(19) United States
(12) Patent Application Publication
(10) Pub. No.: US 2004/0185924 A1
(43) Pub. Date: Sep. 23, 2004

(54) Portable radiotelephone for providing a reduced specific absorption rate

(75) Inventors: Jae-Ho Hwang, Gyeongju-shi (KR); Jae-Min Lee, Songnam-shi (KR); Yong-Seong Jeong, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/392,053

(22) Filed: Mar. 19, 2003

(51) Int. Cl. H04Q 7/20

(52) U.S. Cl. 455/575.3; 455/575.1; 455/90.3

(57) ABSTRACT

The present invention relates to a folder-type portable radiotelephone having a main body including a printed circuit board, and a subbody including an LCD (Liquid Crystal Display) module. The subbody is connected to the main body in such a way that the subbody can be folded and unfolded by a hinge device. The radiotelephone comprises at least one connection device mounted on a portion where the main body meets with the subbody. The connection device electrically connects a grounding portion of the printed circuit board included in the main body to a grounding portion of the LCD module included in the subbody when the radiotelephone is folded and unfolded. Consequently, current density radiated from an antenna device is reduced, contributing to a remarkable reduction in SAR (Specific Absorption Rate).

### BACKGROUND OF THE INVENTION

1. Field of the Invention

The present invention relates generally to a portable radiotelephone, and in particular, to an SAR (Specific Absorption Rate) reduction apparatus for a folder-type portable radiotelephone, for reducing high current density radiated from an antenna device through a contact portion between a main body and a subbody.

2. Description of the Related Art

With the recent popularization of portable radiotelephones and the rapid development of the electronics industry, various devices for shielding electromagnetic waves that are harmful to the human body or reducing a specific absorption rate (SAR) have been proposed. Particularly, in EMI (electromagnetic interference) standard for body protection, the SAR serves as a measure indicating an amount of electromagnetic waves absorbed into the human body (especially the head).

Generally, a portable radiotelephone is used in contact with the human body during a call, so the SAR is affected by a near field of electromagnetic waves radiated from an antenna device of the radiotelephone. Therefore, the SAR is closely related to transmission power, antenna characteristics, and a mechanical structure of the radiotelephone.

In order to reduce the SAR, various methods have been proposed, such as using a unidirectional antenna, and attaching a separate conductive plate onto the radiotelephone or inserting an electromagnetic wave absorbing substance into the radiotelephone to shield electromagnetic waves.

However, the former method of using a unidirectional antenna is very complex in structure and is disadvantageous to the miniaturization and compactness of the radiotelephone. The latter method using an electromagnetic wave shielding substance or an electromagnetic wave absorbing substance has a different effect according to characteristics of the substances and their attachment positions, and has a complicated manufacturing process.

In most cases, although a portion where an LCD (Liquid Crystal Display) module is mounted on a subbody of the folder-type radiotelephone is coated with an electromagnetic wave shielding substance, strong electromagnetic waves radiated from an antenna device are undesirably discharged through a gap between a main body and a subbody of the radiotelephone. Of course, though a flexible printed circuit board (FPC) is installed to electrically connect an LCD module mounted on the subbody to a printed circuit board (or an RF (Radio Frequency) board) mounted on the main body, the installation of the FPC is not sufficient to reduce the strong electromagnetic waves radiated from the antenna device to the outside of the radiotelephone.

### SUMMARY OF THE INVENTION

It is, therefore, an object of the present invention to provide an apparatus for reducing a specific absorption rate (SAR) of a folder-type portable radiotelephone, wherein an adjacent structure of an antenna device is so improved as to reduce high current density radiated from the antenna device.

It is another object of the present invention to provide an SAR reduction apparatus for a folder-type portable radiotelephone, formed to reduce high current density radiated from an antenna device to a mechanical surface of the radiotelephone.

It is further another object of the present invention to provide an SAR reduction apparatus for a folder-type portable radiotelephone, formed in such a way that the SAR reduction apparatus is enabled when a subbody of the radiotelephone is unfolded.

To achieve the above and other objects, there is provided a folder-type portable radiotelephone having a main body including a printed circuit board, and a subbody including an LCD (Liquid Crystal Display) module, wherein the subbody is connected to the main body so that the subbody can be folded against and unfolded from the main body by a hinge device. The radiotelephone comprises at least one connection device mounted on a portion where the main body meets with the subbody. The connection device electrically connects a grounding portion of the printed circuit board mounted on the main body to a grounding portion of the LCD module mounted on the subbody when the radiotelephone is folded and unfolded.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view illustrating a conventional folder-type portable radiotelephone;

FIGS. 2A to 2C are cross-sectional views illustrating a proposed SAR reduction apparatus for a folder-type portable radiotelephone according to a first embodiment of the present invention, wherein a ball plunger is applied;

FIG. 3 is a cross-sectional view illustrating an SAR reduction apparatus for a folder-type portable radiotelephone according to a second embodiment of the present invention, wherein a plate spring is applied;

FIG. 4 is a cross-sectional view illustrating a SAR reduction apparatus for a folder-type portable radiotelephone according to a third embodiment of the present invention, wherein a rotatable metal link is applied;

FIGS. 5A and 5B illustrate distribution of electric field strength at an adjacent portion of an antenna device of a conventional radiotelephone and a proposed radiotelephone, respectively; and

FIGS. 6A and 6B illustrate radiation patterns of a conventional radiotelephone and a proposed radiotelephone, respectively.

### DETAILED DESCRIPTION OF THE PREFERRED EMBODIMENT

Several preferred embodiments of the present invention will now be described in detail with reference to the annexed drawings. In the drawings, the same or similar elements are denoted by the same reference numerals even though they are depicted in different drawings. In the following description, detailed descriptions of known functions and configurations incorporated herein have been omitted for conciseness.

According to the present invention, an electric connection device is mounted on an adjacent portion of an antenna device, where a subbody of a folder-type portable radiotelephone contacts with a main body of the radiotelephone, in order to reduce current density that is radiated to the outside of the radiotelephone, thereby contributing to a drastic reduction in a specific absorption rate (SAR) into the human body. Specifically, the present invention provides a structure for electrically connecting a grounding portion of a first module of the main body to a grounding portion prepared in a second module of the subbody. Preferably, the present invention provides a structure for electrically connecting a grounding portion of the first module included in the main body to a grounding portion of the second module included in the subbody constantly. In addition, the present invention provides a structure for electrically connecting a grounding portion of the first module included in the main body to a grounding portion of the second module included in the subbody while the subbody is unfolded from the main body. The first module can be a printed circuit board serving as an RF board mounted on the main body, and the second module can be an LCD module mounted on the subbody. Hereafter, the several preferred embodiments of the present invention are described with the printed circuit board as an example of the first module, and with the LCD module as an example of the second module.

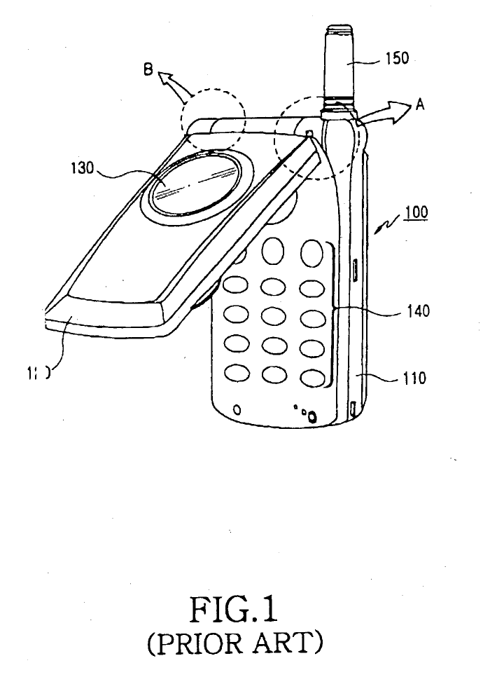

FIG. 1 is a perspective view illustrating a structure of a general folder-type portable radiotelephone. Referring to FIG. 1, a folder-type portable radiotelephone 100 includes a main body 110 with an upper casing frame and a lower casing frame, a subbody 120 connected to the main body 110 in such a way that it can be folded and unfolded to/from the main body 110 by a hinge operation, an LCD module (or display device) 130 mounted on the subbody 120, a keypad 140 having a plurality of key buttons mounted on the main body 110 to input data, and an antenna device 150 installed in the main body 110.

An adjacent portion of the antenna device 150, i.e., a portion (represented by A and B in FIG. 1) where the main body 110 meets with the subbody 120, is a portion that receives most of the high current density radiated from the antenna device 150. In particular, the portion A nearest to the antenna device 150 becomes a portion where the human body is most significantly affected by the electromagnetic waves during a call due to the high current density.

Therefore, an SAR reduction apparatus proposed by the present invention should be mounted on the portion A of FIG. 1. Preferably, the SAR reduction apparatus should be mounted on both the portion A and the portion B of FIG. 1.

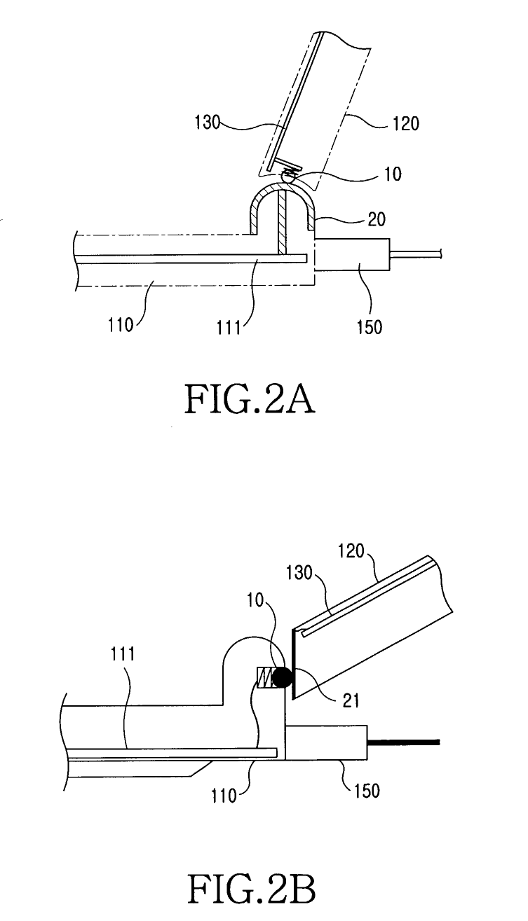

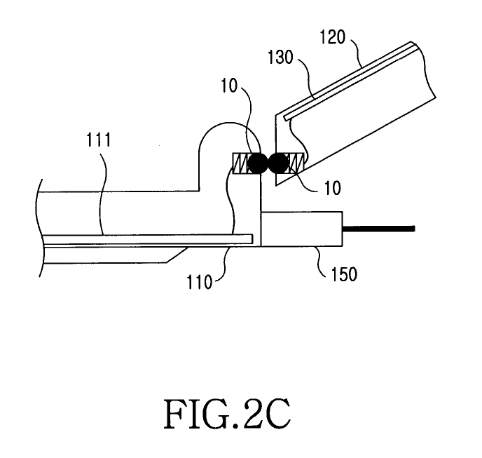

FIGS. 2A to 2C are cross-sectional views illustrating a proposed SAR reduction apparatus for a folder-type portable radiotelephone according to a first embodiment of the present invention, wherein a ball plunger is applied. Referring to FIG. 2A, a ball plunger 10 with a spring is mounted on the subbody 120, and a metal plate 20 is mounted on the main body 110 so that the metal plate 20 can be constantly electrically connected to the ball plunger 10, a portion of which is protruded from the subbody 120. The metal plate 20 can be exposedly mounted on a hinge arm of the main body 110. The ball plunger 10 is electrically connected to a grounding means of the subbody 120, and the metal plate 20 is also electrically connected to a grounding means of a printed circuit board 111 of the main body 110. For the electrical grounding, both ends of a particular conducting wire or an FPC (Flexible Printed Circuit board) can be connected by soldering. For example, the grounding means of the subbody 120 represents a grounding portion of the LCD module, and the grounding means of the main body 110 represents a printed circuit board.

In an alternative embodiment of FIG. 2B, a ball plunger 10 is mounted on the main body 110, and a metal plate 21 is mounted on the subbody 120. In another alternative embodiment of FIG. 2C, ball plungers 10 are separately mounted on the main body 110 and the subbody 120. Both of the ball plungers 10 are electrically connected to their associated grounding portions while the subbody 120 is unfolded from the main body 110.

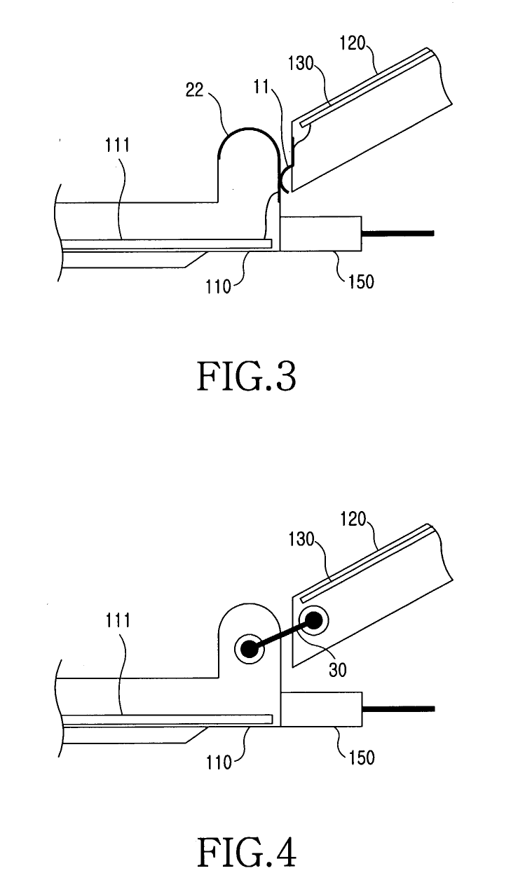

FIG. 3 is a cross-sectional view illustrating an SAR reduction apparatus for a folder-type portable radiotelephone according to a second embodiment of the present invention, wherein a plate spring is applied. Referring to FIG. 3, a plate spring 11 is mounted on the subbody 120, and a metal plate 22 is mounted on the main body 110 in such a way that the metal plate 22 is constantly electrically connected to the plate spring 11. The plate spring 11 is electrically connected to a grounding portion of the LCD module 130 mounted on the subbody 120, and the metal plate 22 is also electrically connected to a grounding portion of a printed circuit board 111 of the main body 110.

On the contrary, though not illustrated, the plate spring can be mounted on the main body and the metal plate can be mounted on the subbody. In addition, if possible, plate springs can be mounted on both the main body and the subbody.

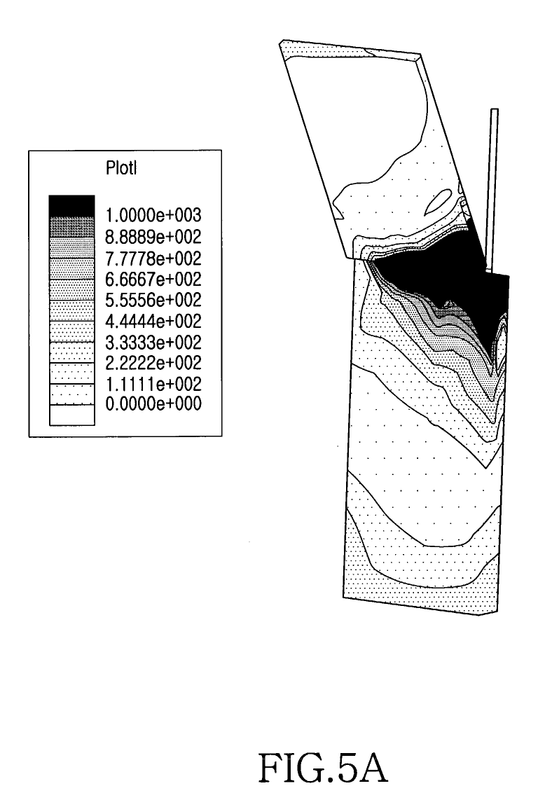

FIG. 4 is a cross-sectional view illustrating a SAR reduction apparatus for a folder-type portable radiotelephone according to a third embodiment of the present invention, wherein a rotatable metal link is applied. Referring to FIG. 4, a metal link 30 is mounted on a particular side of the radiotelephone. Both ends of the metal link 30 are rotatably mounted on the main body 110 and the subbody 120, respectively. One end of the metal link 30 is electrically connected to a grounding portion of the printed circuit board 111 mounted on the main body 110, and another end of the metal link 30 is electrically connected to a grounding portion of the LCD module 130 mounted on the subbody 120, so the grounding portion of the main body 110 is constantly electrically connected to the grounding portion of the subbody 120. Preferably, the metal link 30 is mounted on a particular portion adjacent to the antenna device 150 of the radiotelephone.

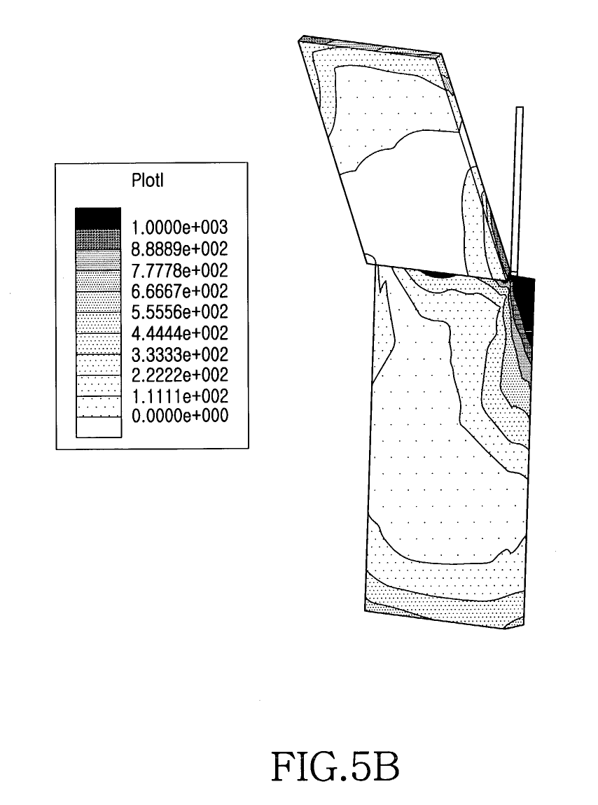

FIGS. 5A and 5B illustrate distribution of electric field strength at an adjacent portion of an antenna device of a conventional radiotelephone and a proposed radiotelephone of the present invention, respectively. Compared with the conventional radiotelephone of FIG. 5A, the proposed radiotelephone of FIG. 5B with the SAR reduction apparatus has remarkably low electric field strength.

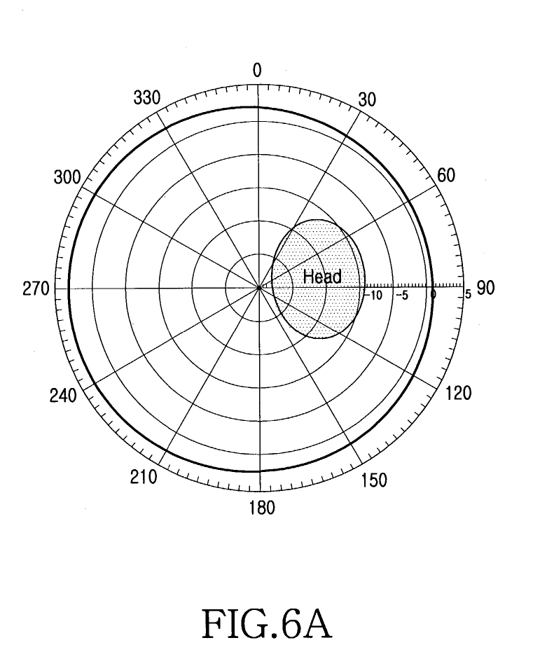

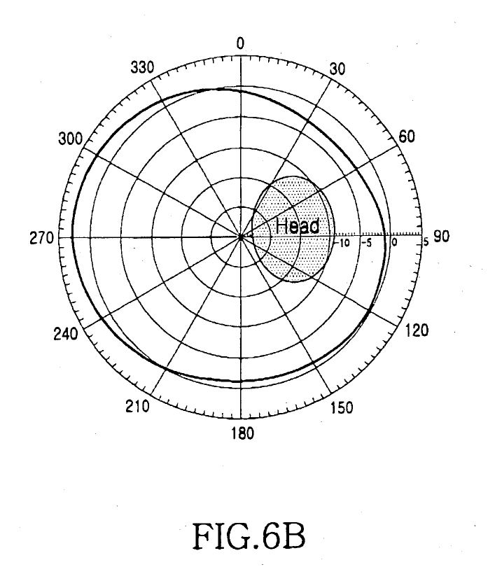

FIGS. 6A and 6B illustrate radiation patterns of a conventional radiotelephone and a proposed radiotelephone, respectively. Compared with the conventional radiotelephone of FIG. 6A, the proposed radiotelephone of FIG. 6B with the SAR reduction apparatus has remarkably low radiation in a direction of the human body.

As described above, an SAR reduction apparatus proposed by the present invention contributes to the miniaturization and compactness of a radiotelephone. In addition, the proposed SAR reduction apparatus is simple in structure, and efficiently reduces SAR.

While the invention has been shown and described with reference to certain preferred embodiments thereof, it will be understood by those skilled in the art that various changes in form and details may be made therein without departing from the spirit and scope of the invention as defined by the appended claims. For example, any other structure for electrically connecting a grounding portion of the main body to a grounding portion of the subbody can be applied to the radiotelephone.

What is claimed is:

1. A portable radiotelephone having a main body including a first module, and a subbody including a second module, wherein the subbody is connected to the main body so that the subbody can be folded against and unfolded from the main body, the radiotelephone comprising:
at least one connection device mounted on a portion where the main body meets with the subbody, wherein the connection device electrically connects a grounding portion of the first module included in the main body to a grounding portion of the second module included in the subbody

2. The portable radiotelephone of claim 1, wherein the connection device comprises:
a ball plunger mounted on the main body so that the ball plunger is electrically connected to the grounding portion of the first module; and
a metal plate mounted on the subbody so that the metal plate is electrically connected to the ball plunger mounted on the main body and is also electrically connected to the grounding portion of the second module included in the subbody.

3. The portable radiotelephone of claim 1, wherein the connection device comprises:
a metal plate mounted on the main body so that the metal plate is electrically connected to the grounding portion of the first module; and
a ball plunger mounted on the subbody so that the ball plunger is electrically connected to the metal plate mounted on the main body and is also electrically connected to the grounding portion of the second module included in the subbody.

4. The portable radiotelephone of claim 1, wherein the connection device comprises:
a plate spring mounted on the main body so that the plate spring is electrically connected to the grounding portion of the first module; and
a metal plate mounted on the subbody so that the metal plate is electrically connected to the plate spring mounted on the main body and is also electrically connected to the grounding portion of the second module included in the subbody.

5. The portable radiotelephone of claim 1, wherein the connection device comprises:
a metal plate mounted on the main body so that the metal plate is electrically connected to the grounding portion of the first module; and
a plate spring mounted on the subbody so that the plate spring is electrically connected to the metal plate mounted on the main body and is also electrically connected to the grounding portion of the second module included in the subbody.

6. The portable radiotelephone of claim 1, wherein the connection device comprises:
a metal link, wherein a first end of the metal link is mounted on the main body so that the first end is electrically connected to the grounding portion of the first module, and a second end of the metal link is mounted on the subbody so that the second end is electrically connected to the grounding portion of the second module.

7. The portable radiotelephone of claim 1, wherein the connection device is mounted on an adjacent portion of an antenna device included in the radiotelephone.

8. The portable radiotelephone of claim 7, wherein the connection device comprises:
a ball plunger mounted on the main body so that the ball plunger is electrically connected to the grounding portion of the first module; and
a metal plate mounted on the subbody so that the metal plate is electrically connected to the ball plunger mounted on the main body and is also electrically connected to the grounding portion of the second module included in the subbody.

9. The portable radiotelephone of claim 7, wherein the connection device comprises:
a metal plate mounted on the main body so that the metal plate is electrically connected to the grounding portion of the first module; and
a ball plunger mounted on the subbody so that the ball plunger is electrically connected to the metal plate mounted on the main body and is also electrically connected to the grounding portion of the second module included in the subbody.

10. The portable radiotelephone of claim 7, wherein the connection device comprises:
a plate spring mounted on the main body so that the plate spring is electrically connected to the grounding portion of the first module; and
a metal plate mounted on the subbody so that the metal plate is electrically connected to the plate spring mounted on the main body and is also electrically connected to the grounding portion of the second module included in the subbody.

11. The portable radiotelephone of claim 7, wherein the connection device comprises:
a metal plate mounted on the main body so that the metal plate is electrically connected to the grounding portion of the first module; and
a plate spring mounted on the subbody so that the plate spring is electrically connected to the metal plate mounted on the main body and is also electrically connected to the grounding portion of the second module included in the subbody.

12. The portable radiotelephone of claim 7, wherein the connection device comprises:
a metal link, wherein a first end of the metal link is mounted on the main body so that the first end is electrically connected to the grounding portion of the first module, and a second end of the metal link is mounted on the subbody so that the second end is electrically connected to the grounding portion of the second module.

13. The portable radiotelephone of claim 1, wherein the first module is a printed circuit board.

14. The portable radiotelephone of claim 1, wherein the second module is an LCD (Liquid Crystal Display) module.

15. The portable radiotelephone of claim 1, wherein the connection device electrically connects a grounding portion of the first module included in the main body to a grounding portion of the second module included in the subbody constantly.

16. The portable radiotelephone of claim 1, wherein the connection device electrically connects a grounding portion of the first module included in the main body to a grounding portion of the second module included in the subbody while the subbody is unfolded from the main body.
